(19) United States
(12) Patent Application Publication
(10) Pub. No.: US 2003/0076981 A1
(43) Pub. Date: Apr. 24, 2003

(54) Method for operating a pre-crash sensing system in a vehicle having a counter-measure system

(76) Inventors: Gregory Hugh Smith, Ann Arbor, MI (US); James Stewart Rankin II, Novi, MI (US); Samuel Edward Ebenstein, Southfield, MI (US); Yelena Mordechai Rodin, Southfield, MI (US)

Correspondence Address: KEVIN G. MIERZWA, ARTZ & ARTZ, P.C., 28333 TELEGRAPH ROAD, SUITE 250, SOUTHFIELD, MI, 48034, US

(21) Appl. No.: 09/682,777

(22) Filed: Oct. 18, 2001

(51) Int. Cl. B60R 21/32; G06K 9/00

(52) U.S. Cl. 382/104; 280/735; 382/106

(57) ABSTRACT

A pre-crash system (10) has a controller (12) coupled to an object sensor (18). Object sensor (18) has a vision system (22) that includes image sensors to detect an impact and in particular, a side impact. The image sensors provide a high frame rate to a video-processing chip (32) which in turn is coupled to a general purpose controller (34). The general-purpose controller 34 determines whether an object is an impending threat and controls the deployment of an airbag through an airbag controller (36) or other counter-measure. The high frame rate used in the present invention allows not only the distance to the object but the velocity of the object as well as the acceleration of the object to be determined and factored into the deployment decision.

### BACKGROUND OF INVENTION

The present invention relates to pre-crash sensing systems for automotive vehicles, and more particularly, to pre-crash sensing systems particularly suited for side impact pre-crash detection.

Auto manufacturers are investigating radar, lidar, and vision-based pre-crash sensing systems to improve occupant safety. Current vehicles typically employ accelerometers that measure forces acting on the vehicle body. In response to accelerometers, airbags or other safety devices are employed.

In certain crash situations it would be desirable to provide information before forces actually act upon the vehicle when a collision is unavoidable. This is particularly important in side impact situations where there is only a relatively small amount of vehicle between an occupant and the exterior of the vehicle as compared to a frontal impact zone.

As mentioned above, known systems employ vision systems to detect the presence of an object in front of the vehicle a predetermined time before an actual crash occurs. However, such systems typically employ a frame rate of 30 frames per second. A side impact determination must be determined significantly faster than a frontal impact because there is much less crash space in the side of a vehicle than in the front. Therefore, adequate data cannot be obtained from such systems to pre-crash sense a side impact.

It would therefore be desirable to provide a pre-crash sensing system that is capable of detecting and deploying occupant protection.

### SUMMARY OF INVENTION

The present invention provides an improved pre-crash sensing system using an image-based system having a response fast enough to perform side impact crash prediction.

In one aspect of the invention, a pre-crash system has a controller coupled to an object sensor. Object sensor has a vision system that includes image sensors to detect an impact and in particular, a side impact. The image sensors provide a high frame rate to a video-processing chip which in turn is coupled to a general purpose controller. The general purpose controller determines whether an object is an impending threat and controls the deployment of an airbag through an airbag controller or other counter-measure. The high frame rate used in the present invention allows not only the distance to the object but the velocity of the object as well as the acceleration of the object to be determined and factored into the deployment decision.

In a further aspect of the invention, a method for operating a per-crash sensing system comprises:

generating a plurality of images of the object from an image device having a frame rate of at least 100 frames per second camera;

determining an object distance with the image device;

determining an object speed and acceleration with the image device as a function of frame rate; and activating the counter measure system in response to the object size, object distance and object acceleration.

One advantage of the invention is that the high frame rate allows rapid determination of various target characteristics that allows the system to determine additional vehicle characteristics such as velocity and acceleration.

Other advantages and features of the present invention will become apparent when viewed in light of the detailed description of the preferred embodiment when taken in conjunction with the attached drawings and appended claims.

### BRIEF DESCRIPTION OF DRAWINGS

FIG. 1 is a block diagrammatic view of a pre-crash sensing system according to the present invention.

FIG. 2 is a top view of an automotive vehicle having a pre-crash sensing that includes two narrow beam radar sensors.

FIG. 3 is a flowchart of a method for operating the pre-crash sensing system according to the present invention.

### DETAILED DESCRIPTION

In the following figures the same reference numerals will be used to identify the same components. While the present invention is illustrated with respect to several types of object sensors and positions, various types and combinations of object sensors and positions may be used as will be further described below.

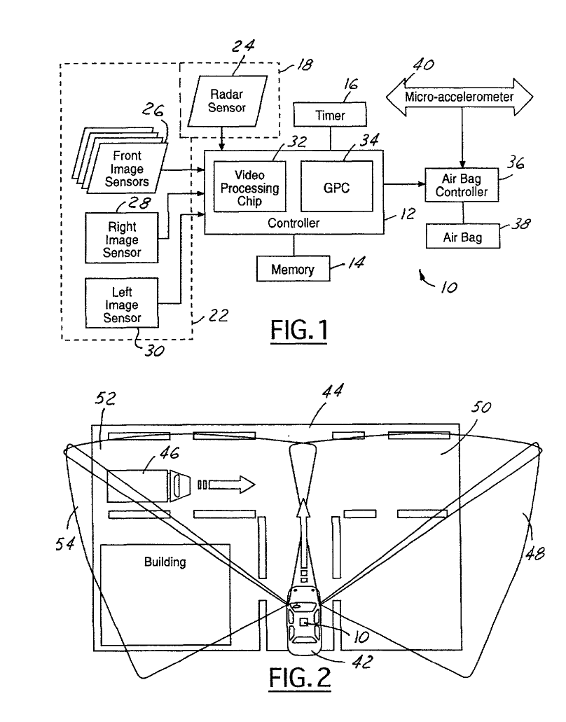

Referring now to FIG. 1, a pre-crash system 10 has a controller 12. Controller 12 is preferably a microprocessor-based controller that is coupled to a memory 14 and a timer 16. Memory 14 and timer 16 are illustrated as separate components from that of controller 12. However, those skilled in the art will recognize that memory 14 and timer 16 may be incorporated into controller 12.

Memory 14 may comprise various types of memory including read only memory, random access memory, electrically erasable programmable read only memory, and keep alive memory. Memory 14 is used to store various thresholds and parameters as will be further described below.

Timer 16 is a timer such as a clock timer of a central processing unit within controller 12. Timer 16 is capable of timing the duration of various events as well as counting up or counting down from a trigger.

An object sensor 18 is coupled to controller 12. Object sensor 18 generates an object signal in the presence of an object within the line of sight thereof. Object sensor 18 may be comprised of one or a number of types of sensors including a vision system 22 and an optional radar sensor 24. Vision system 22 may be comprised of one or more cameras or CCD type devices. As illustrated, vision system 22 includes a front image device 26 and a right side image device 28, a left side image device 30. Each image device is preferably a digital camera having a frame rate of at least 100 frames per second. More preferably, the frame rate may be about 400 or more. Each front image device, and the side image devices 28, 30 may actually be comprised of a stereo pair of cameras that when acting together are capable of detecting the distance of an object from the vehicle.

Radar 24 is capable of sensing the presence and the distance of an object from the vehicle. When used as a stereo pair, the cameras are also capable of detecting the distance of an object from the vehicle.

Controller 12 has a video-processing chip 32 for digitally processing the image signals from the vision system having a general-purpose computer 34 coupled thereto. The video-processing chip 32 may, for example, generate an object distance, object velocity and object acceleration signals as will be further described below from the images and the known frame rate. Based on the signals, general-purpose computer determines whether to deploy a countermeasure such as an airbag or the like. As will be further described below, radar 24 may be used to detect an object within a detection zone which in turn may trigger the vision system 26 to provide images. The image sensors may use a well-known triangulation technique to determine the presence of an object and the distance from the vehicle as well as various properties of the object such as which may include area, height or width, or combinations thereof.

Controller 12 is coupled to a counter-measure system such as an airbag controller 36 coupled to an airbag 38. Controller 12 may control the deployment of airbag 38 through pre-crash sensing. Airbag controller 36 may also be coupled to a microaccelerometer or plurality of microaccelerometers 40. Thus, airbag controller 36 may factor the airbag deployment signal from controller 12 and the signals from microaccelerometer 40 into a deployment decision. Microaccelerometer 40 may for example, include lateral acceleration and longitudinal acceleration.

Referring now to FIG. 2, an automotive vehicle 42 having system 10 is illustrated.

Automotive vehicle 42 is positioned on a road 44 relative to a target vehicle 46. Pre-crash sensing system 10 generates a right side beam 48, a first front beam 50, a second front beam 52, and a left side beam 54. As is shown in the figure, the target vehicle may be entirely within one beam or partially within two beams. In FIG. 2, beams 52 and 54 contain a portion of target vehicle 46. Video processing chip 32 of controller 12 may compensate for the moving vehicle, i.e., track the target in a known manner.

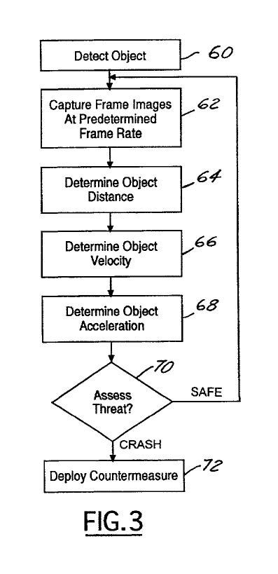

Referring now to FIG. 3, a method for operating a pre-crash sensing system according to the present invention is shown. In the present invention an object is detected in one of the various manners set forth above. For example, an object may be detected by radar which then triggers an image processing system. Imagine processing system may also detect an object in step 60. Once an object has been detected frame images are captured at a predetermined frame rate. Preferably, the predetermined frame rate is such to allow a sufficient amount of time for deployment of a counter-measure such as a side impact airbag. As the frame rates are captured, the object distance can be determined from comparing the frames in step 64.

In step 66, the object velocity may be determined by comparing the movement of the object from succeeding frames. In step 68, by obtaining velocity information in step 66 the acceleration between frames can be determined. The acceleration is the change in velocity. Therefore, if two velocities are obtained from consecutive sets of frames in step 66, the acceleration can be determined. In step 70, the measured parameters such as acceleration and velocity are monitored to determine whether a crash is imminent. If a crash is not imminent, then step 62 is again executed. If a crash is imminent then step 72 is executed. In step 72, deployment of a counter-measure is performed. The deployment of a counter-measure as mentioned above may be a side airbag, a frontal driver side airbag, frontal passenger side airbag, or passenger side airbag. Of course, other types of airbags such as side curtains may be employed. Other types of counter-measures may also be employed including changing the direction of the vehicle through steering control, or application of the brake through a brake controller. Advantageously, the increased frame rate of the present invention allows the determination of velocity and acceleration of the system as well as verifying that the velocities and accelerations are within a range of an oncoming object that poses a threat rather than a non-threat such as a garbage bag or balloon which is blown by the wind. Other counter-measure devices that may be employed in addition to or in place of airbags include head restraints, pedal control, steering column position control, pedestrian protection, knee bolster control, and seat belt pretensioning control.

While particular embodiments of the invention have been shown and described, numerous variations and alternate embodiments will occur to those skilled in the art. Accordingly, it is intended that the invention be limited only in terms of the appended claims.

1. A pre-crash sensing system coupled to a counter-measure system for sensing an object comprising:
a vision system producing a plurality of frames at a rate of at least about 100 frames per second;
a video processor coupled to said vision system, said video processor determining a distance, velocity and an acceleration of the object from said plurality of frames; and
a controller coupled to said vision system for deploying said counter measure in response to said object distance, object velocity and said object acceleration.

2. A system as recited in claim 1 wherein said vision system comprises a right side camera, and a left side camera.

3. A system as recited in claim 2 wherein said vision system comprises a front camera.

4. A system as recited in claim 3 wherein said front camera comprises a stereo pair of cameras.

5. A system as recited in claim 1 further comprising a forward looking radar-based system.

6. A system as recited in claim 1 wherein said counter measure comprises an airbag controller and an airbag, said airbag controller coupled to said airbag.

7. A system as recited in claim 6 wherein said airbag comprises a side airbag.

8. A system as recited in claim 7 wherein said side airbag comprises a side curtain airbag.

10. A pre-crash side-impact sensing system for an automotive vehicle for sensing an object comprising:
a camera vision system producing a plurality of frames at a rate of at least about 100 frames per second;
a video processor coupled to said vision system, said video processor determining a distance, velocity and an acceleration of the object from said plurality of frames; and
a controller coupled to said vision system for deploying said counter measure in response to said object distance, object velocity and said object acceleration.

11. A system as recited in claim 10 wherein said vision system comprises a right side camera, and a left side camera.

12. A system as recited in claim 11 wherein said vision system comprises a front camera.

13. A system as recited in claim 12 wherein said front camera comprises a stereo pair of cameras.

14. A system as recited in claim 10 further comprising a forward looking radar-based system.

15. A system as recited in claim 10 wherein said counter measure comprises an airbag controller and an airbag, said airbag controller coupled to said airbag.

16. A system as recited in claim 15 wherein said airbag comprises a side airbag.

17. A system as recited in claim 16 wherein said side airbag comprises a side curtain airbag.

18. A method for operating a pre-crash sensing system for an automotive vehicle having a counter-measure system, said method comprising:
generating a plurality of images of the object from an image device having a frame rate of at least 100 frames per second camera;
determining an object distance with the image device;
determining an object speed and acceleration with the image device as a function of frame rate; and
activating the counter measure system in response to the object size, object distance and object acceleration.

19. A method as recited in claim 10 wherein deploying the counter-measure comprises deploying an airbag.

20. A method as recited in claim 18 wherein deploying an airbag comprises deploying a side airbag.

21. A method as recited in claim 18 wherein deploying a side airbag comprises deploying a side curtain airbag.
